(19) United States
(12) Patent Application Publication
(10) Pub. No.: US 2025/0290639 A1
(43) Pub. Date: Sep. 18, 2025

(54) DOMESTIC APPLIANCE

(71) Applicant: Paul Hettich GmbH & Co. KG, Kirchlengern (DE)

(72) Inventors: Johann BRAUN, Hiddenhausen (DE); Johann-Sebastian LESSMANN, Löhne (DE); Hendrik MARTINETZ, Münster (DE)

(73) Assignee: Paul Hettich GmbH & Co. KG, Kirchlengern (DE)

(21) Appl. No.: 19/078,528

(22) Filed: Mar. 13, 2025

(30) Foreign Application Priority Data
Mar. 14, 2024 (DE) 10 2024 107 302.0

(51) Int. Cl. F24C 15/16

(52) U.S. Cl. CPC F24C 15/16

(57) ABSTRACT

A domestic appliance includes an interior space for receiving a rack system, a wall element on each of the opposite sides of the interior space and a locking projection arranged on at least one of the wall elements. There is a stationary part, and a movable part movable at least partially in front of the interior space via guides. A locking element is pivotably mounted on the stationary part for releasable engagement with the locking projection, which can be moved into an unlocked position via a driver on the movable part. The locking element has a locking section that is engageable with the locking projection and a first actuating section which is engageable with the driver. The locking element has a second actuating section engageable with the drive. The driver is held between the first actuating section and the second actuating section in the unlocked position of the locking section.

### CROSS REFERENCE TO RELATED APPLICATIONS

Applicant claims priority under 35 U.S.C. § 119 of German Application No. 10 2024 107 302.0 filed Mar. 14, 2024, the disclosure of which is incorporated by reference.

### BACKGROUND OF THE INVENTION

### 1. Field of the Invention

The present invention relates to a domestic appliance with an interior space for accommodating a rack system, wherein a wall element is provided on each of the opposite sides of the interior space and a locking projection is arranged on at least one of the wall elements, wherein the rack system has a stationary part arranged in the interior space and a part which can be moved at least partially in front of the interior space via guides, and a locking element is pivotably mounted on the stationary part for releasable engagement with the locking projection, which locking element can be moved into an unlocked position via a driver on the movable part, the locking element having a locking section which can be brought into engagement with the locking projection and a first actuating section which can be brought into engagement with the driver.

### 2. Description of the Related Art

US 2012/0097147 A1 discloses an oven in which a rack system is arranged in an interior of the oven muffle. The rack system comprises a stationary part that remains in the oven and a part that can be pulled out on the interior. When the movable part of the rack system is pulled out, a rotating latch ensures that the stationary part is locked in the oven. This increases safety when handling and preparing food. The latch is pretensioned into the locked position by a spring and can be brought into engagement with a projection for locking. When the movable part is retracted, a driver ensures that the latch swivels against the spring force to unlock it. The use of a spring in the oven is disadvantageous because, particularly at high temperatures, for example during pyrolytic cleaning, damage can be associated with an impairment of the pre-tensioning force. In addition, the locking mechanism requires numerous components, which makes assembly and production time-consuming.

U.S. Pat. No. 10,548,396 B1 shows a sliding device for a movable rack that can be moved on opposite sides via a guide in the pull-out direction. A hook is provided at the rear end of a stationary part, which can be moved against the force of a spring when the rack is pushed into a raised position. When the rack is pulled out, the hook engages behind a locking mechanism on the rear wall and is preloaded into the locked position by the spring. The locking mechanism therefore requires additional installation space. US 2021/0071876 A1 also shows a similar rack device.

### SUMMARY OF THE INVENTION

It is therefore the object of the present invention to create a domestic appliance in which a rack system can be reliably locked in an interior space by simple means.

This object is solved according to the invention with a domestic appliance that comprises an interior space for accommodating a rack system, wherein a wall element is provided on each of the opposite sides of the interior space and a locking projection is arranged on at least one of the wall elements. The rack system has a stationary part arranged in the interior space and a part which can be moved at least partially in front of the interior space via guides. A locking element is pivotably mounted on the stationary part for releasable engagement with the locking projection, which locking element can be moved into an unlocked position via a driver on the movable part. The locking element has a locking section that can be brought into engagement with the locking projection, a first actuating section that can be brought into engagement with the driver and a second actuating section that can be brought into engagement with the driver. The driver is held between the first actuating section and the second actuating section in the unlocked position of the locking section. As a result, the first actuating section and the second actuating section ensure positive guidance of the locking element, since the driver bears against the first actuating section during a movement in the pull-in direction and bears against the second actuating section during a movement in the pull-out direction, so that positive guidance is ensured via the locking element and the driver, which ensures reliable locking during a pull-out movement of the driver, which can be provided with few components in a compact design.

Preferably, the locking element can be pivoted relative to the stationary part without the support of a spring. The use of springs on the locking element can be dispensed with, as such springs increase the susceptibility to errors.

For a simple design, the locking element can be rotatably mounted with a bearing section around a pin on the stationary part. The axis can be formed by a pin or a wire section on the stationary part, whereby the axis is preferably aligned essentially vertically, optionally also with a slight inclination to the vertical. This allows the locking element to be pivoted independently of the influence of gravity, so that the weight forces of the locking element are negligible.

In a further embodiment, the first actuating section and the second actuating section are designed to protrude in different radial directions in relation to an axis of rotation of the locking element. This allows the driver to be arranged between the two actuating sections in the unlocked position. The actuating sections can preferably be designed as web-shaped tabs, but can optionally also be produced in an arcuate shape or with a different geometry. In addition, a further cantilever can be formed on the locking element, which forms a stop in the locking position in order to block a rotary movement of the locking element.

In order to manufacture the locking mechanism with few components, the locking element is preferably made in one piece. The locking element can be made from a metal sheet and have an integrally formed bearing section that is used for rotatable mounting on the stationary part.

In a further embodiment, the locking projection is arranged in the area of a front half of the wall element in relation to an extension direction of the movable part. This allows the locking mechanism to be provided in a front area of the wall element so that the overall length of the rack system can be varied, so that different overall lengths of the rack system can be produced with the identical locking mechanism.

Preferably, the driver is designed as a projection that protrudes downwards and/or laterally on the movable part. The movable part can be designed as a grid, for example, so that the driver is designed as a projection made of a wire. The driver can preferably protrude downwards from a support surface in a V-shape or with a different geometry in order to move the locking element during a movement into the retracted position.

A receptacle is preferably formed on the locking projection, into which an end section of the locking section can be inserted. This allows a wall of the receptacle to form a stop against which the locking section presses in the locked position. For stable locking, a locking section provided on the locking element can be subjected to pressure when a tensile force is applied to the stationary part in the pull-out direction. This ensures that even high forces on the stationary part can be reliably transferred to the wall element. The locking element can thus be locked in a self-locking manner, i.e. when a tensile force is applied to the stationary part in the pull-out direction, the locking element is pressed even more strongly into the locked position, in particular by generating a torque on the locking element, which makes unintentional unlocking more difficult.

For smooth handling of the rack system, the stationary part can comprise a first rail and the movable part a second rail, which are held together in a movable manner via rolling elements. Optionally, a pull-out extending middle rail can be provided between the first rail and the second rail, depending on how far the movable part of the rack system is to be moved in front of the interior space. Preferably, the rails are part of a pull-out guide that is arranged between the stationary part and the movable part of the rack system. The rack system thus forms a compact unit that can be easily removed from the interior space of the oven.

For secure locking of the rack system, a locking element can be provided on the stationary part adjacent to each wall element, which can be brought into engagement with a locking projection. As a result, the stationary part is locked on opposite sides when the movable part of the rack system is pulled out of the interior space. The locking element can be formed by a bent wire, a metal lead or hook-shaped elements. The locking element preferably engages centrally on a locking projection of a wall element, whereby the wall element can be formed from an embossed metal sheet or a side grid, for example.

In a first variant, the locking projection on a wall element is made from an embossed metal sheet. Optionally, the locking projection can be formed integrally with a support strip, which serves to hold the stationary part of the rack system, whereby the locking projection is produced, for example, by a V-shaped embossing. In a second variant, the locking projection is formed on a side rail, for example made of wire with vertical posts and horizontal webs, which is fixed to a wall on the interior space.

In a preferred embodiment, the domestic appliance is designed as an oven. Alternatively, the domestic appliance can also be designed as a microwave, steamer, refrigerator, wine cooler or another appliance for preparing food.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows a perspective view of a domestic appliance according to the invention;

FIG. 2 shows a perspective view of the rack system in the retracted position;

FIG. 3 shows a perspective view of the rack system with the movable part in a protruding position;

FIG. 4 shows a perspective view of the stationary part on the wall elements;

FIG. 5 shows a detailed view of the locking mechanism of the rack system in the unlocked position;

FIG. 6 shows a detailed view of the locking mechanism according to FIG. 5 in the locked position;

FIG. 7 shows a perspective view of the locking mechanism of FIG. 5 without wall element;

FIG. 8 shows a detailed view of the locking mechanism without wall element in the locked position;

FIG. 9 shows a view of the locking element of the locking mechanism;

FIG. 10 shows a front view of the locking mechanism in the mounted position in the unlocked position;

FIG. 11 shows a detailed view of the locking mechanism according to FIG. 10 in the locked position;

FIG. 12 shows a modified embodiment of a locking mechanism, and

FIGS. 13A, 13B, and 13C show views of different variants for fixing the locking element to the pin.

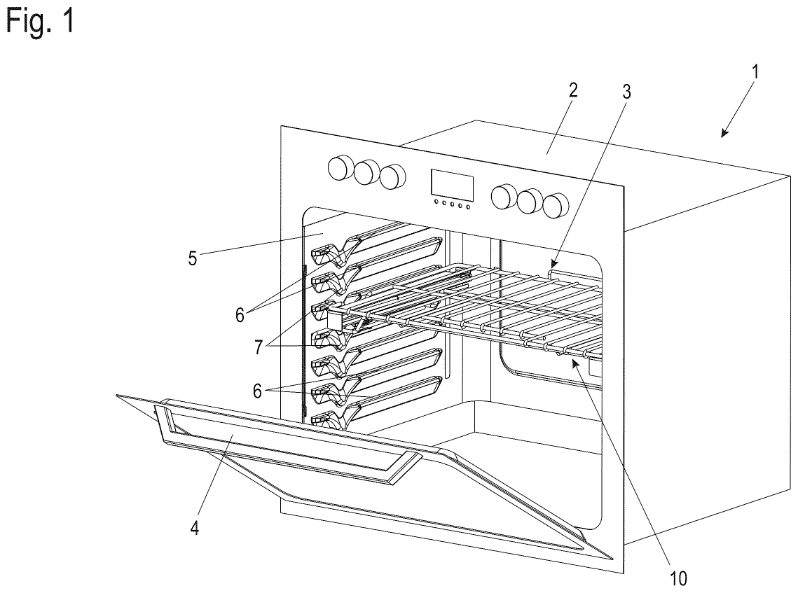

### DETAILED DESCRIPTION OF PREFERRED EMBODIMENTS

A domestic appliance 1 is designed as an oven and comprises a housing 2, in particular made of a metal sheet, in which an interior space 3 is provided. The interior space 3 is open at one front side and can be closed by a hinged door 4.

A wall element 5 is provided on opposite sides of the interior space 3, which is made of a profiled metal sheet and has several support strips 6 for supporting food carriers or one or more rack systems 10. A locking projection 7 is formed on each support strip 6, which is produced as an inwardly projecting V-shaped embossing, but can also be provided with other geometries on the wall element 5.

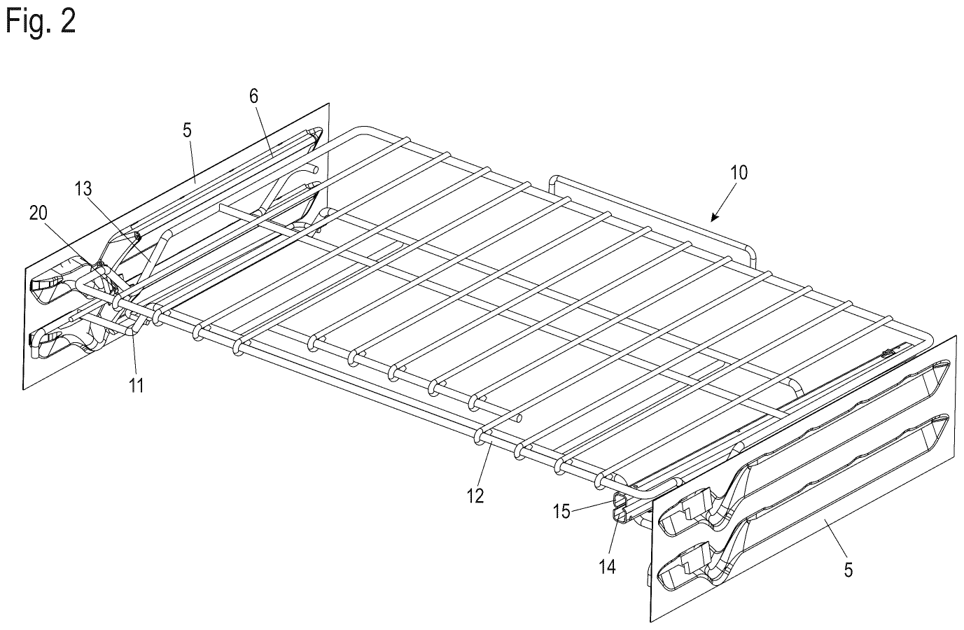

As shown in FIG. 2, the rack system 10 comprises a stationary part 11, which rests on support strips 6 on opposite sides and remains in the interior space 3. Furthermore, the rack system 10 comprises a movable part 12, which is held on opposite sides via guides on the stationary part 11 and can be moved into a position in front of the interior space 3. If the movable part 12 is moved by the stationary part 11 into a pull-out position, the stationary part 11 is fixed to a wall element 5 via at least one locking mechanism.

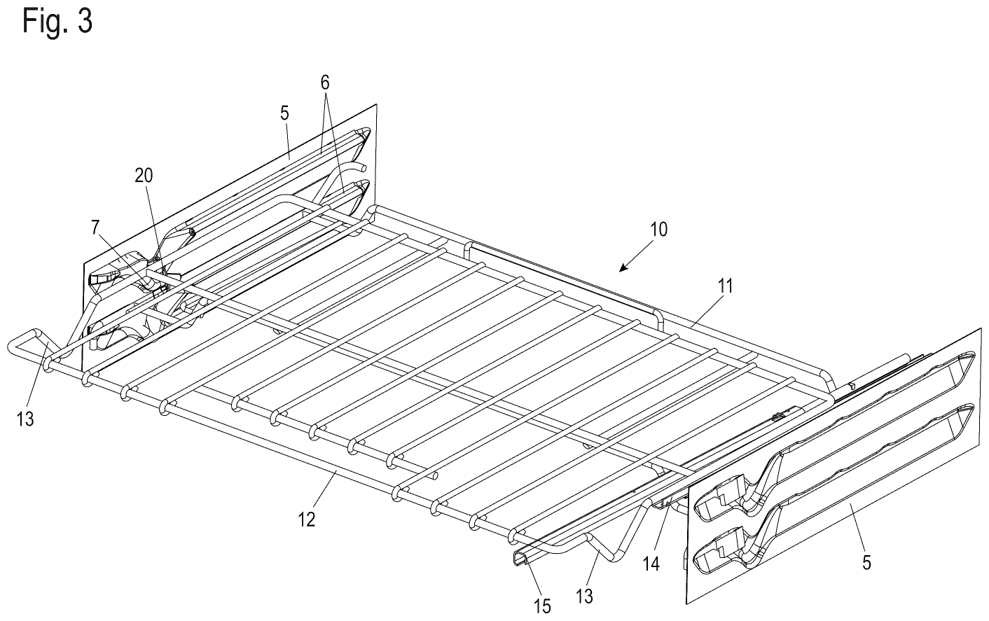

In FIG. 3, the rack system 10 is shown in a locked position, in which the movable part 12 has been moved relative to the stationary part 11 to a protruding position. A movable rail 15, to which the movable part 12 is fixed, has been moved relative to a stationary rail 14, which is fixed to the stationary part 11. The rails 14 and 15 can optionally be connected to each other via a pull-out extending middle rail. In FIG. 3, the pull-out guide with the rails 14 and 15 is only shown on the right-hand side, while on the left-hand side the pull-out guide has been omitted so that a locking element 20 is visible, which serves to lock the stationary part 11 to the locking projection 7.

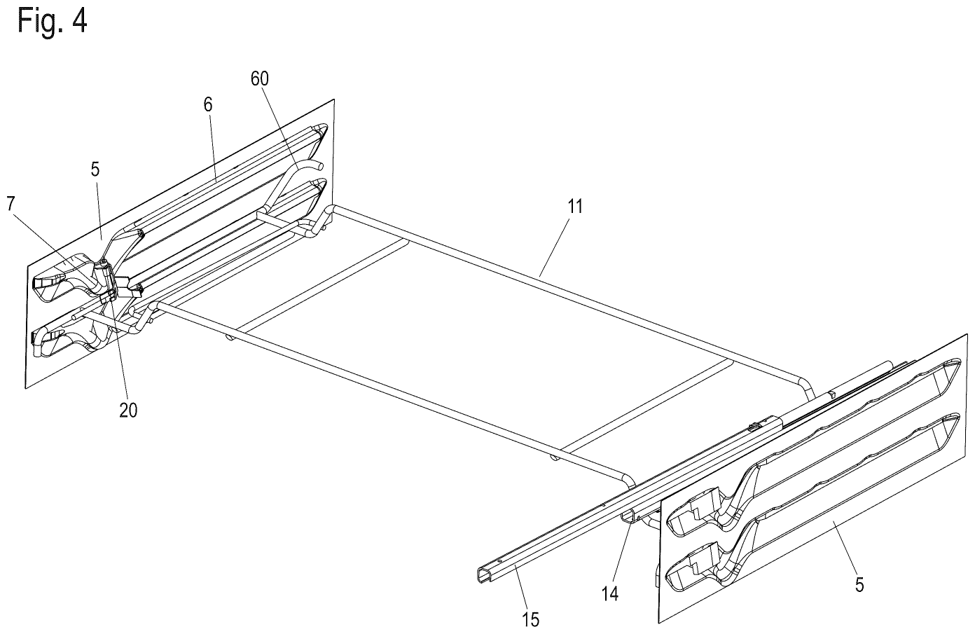

In FIG. 4, only the stationary part 11 of the rack system 10 is shown between the two wall elements 5. The stationary part 11 rests on opposite sides with a strut on a support strip 6 of the wall element 5 and has an upwardly projecting cantilever 60 at the rear end, which is supported on the underside of a further support strip 6, so that a tilting movement of the stationary part 11 is avoided when the movable part 12 is loaded with a weight load in a projecting position. A downwardly projecting locking projection 7 is formed on each support strip 6, on each of which a locking element 20 can be provided. The locking element 20 is rotatably mounted on the stationary part 11.

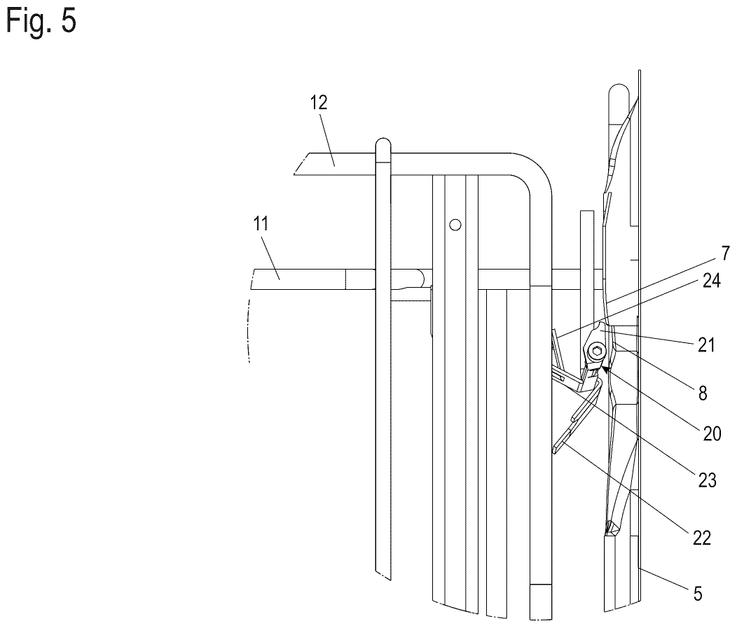

FIG. 5 shows the locking mechanism in detail. The locking element 20 comprises a protruding locking section 21, which is arranged adjacent to the locking projection 7 in the unlocked position. A receptacle 8 is formed on the locking projection 7, into which one end of the locking section 21 can be inserted in the locked position. In the unlocked position, the locking section 21 can be moved past the locking projection 7 in the pull-out direction.

The locking element 20 further comprises a first actuating section 22, which is engageable with the driver 13 on the movable part 12 when the movable part 12 is displaced from a protruding position to a retracted position. A second actuating section 23 is also provided on the locking element 20, which is pivotable together with the first actuating section 22 and which can be actuated by the driver 13 when the movable part 12 is moved in the pull-out direction.

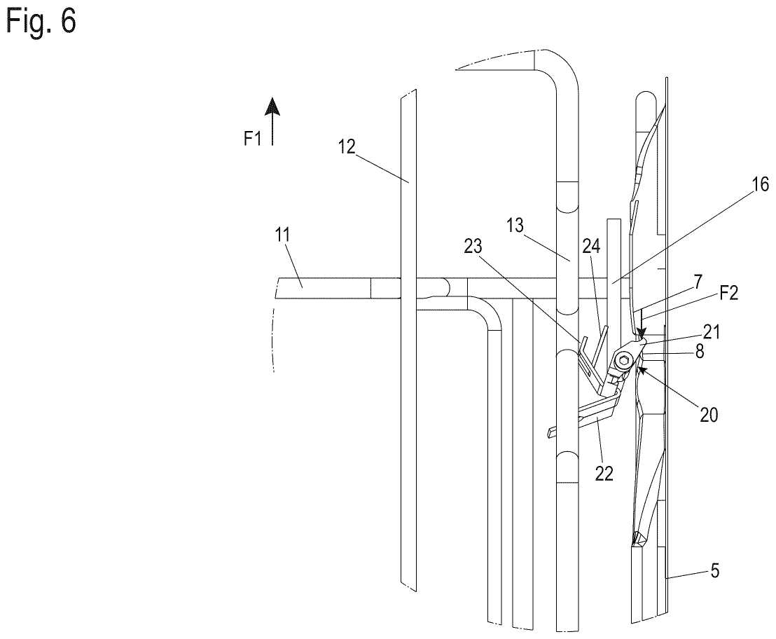

FIG. 6 shows the locked position of the locking mechanism. By moving out the movable part 12 and the driver 13, the locking element 20 has been pivoted clockwise so that one end of the locking section 21 engages in the receptacle 8 on the locking projection 7. If a force now acts on the stationary part 11 in the pull-out direction, the locking section 21 contacts the locking projection 7 and prevents movement, whereby the locking section 21 is subjected to pressure.

The locking element 20 has been pivoted by the driver 13 during the extension movement, as the driver 13 presses against the second actuating section 23 and thus pivots the entire locking element 20. The pivoting movement ends when a cantilever 24 strikes against a web 16 of the stationary part 11, so that the rotary movement is limited. This limitation of the rotary movement can also be implemented differently, for example by the cantilever 24 resting against the stationary part 11 of the guide

In the locked position, the locking element 20 is self-locking. If a tensile force F₁ is exerted on the stationary part 11 in the pull-out direction, a counterforce F₂ from the locking projection 7 acts on the locking element 20, which is pressed even more strongly into the locked position by this counterforce F₂ due to the resulting torque.

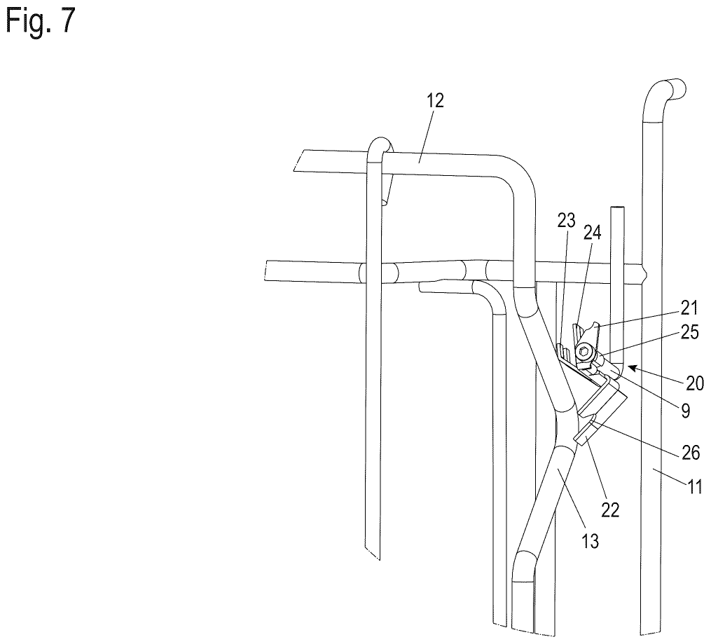

As shown in FIG. 7, the locking element 20 comprises a bearing section 25, which is arranged around a pin 9 on the stationary part 11. The bearing section 25 and the pin 9 define the axis of rotation, which is aligned vertically in the embodiment example shown. A recess 26 is formed on the first actuating section 22, into which a section of the V-shaped driver can engage when the movable part 12 is moved in the extension direction.

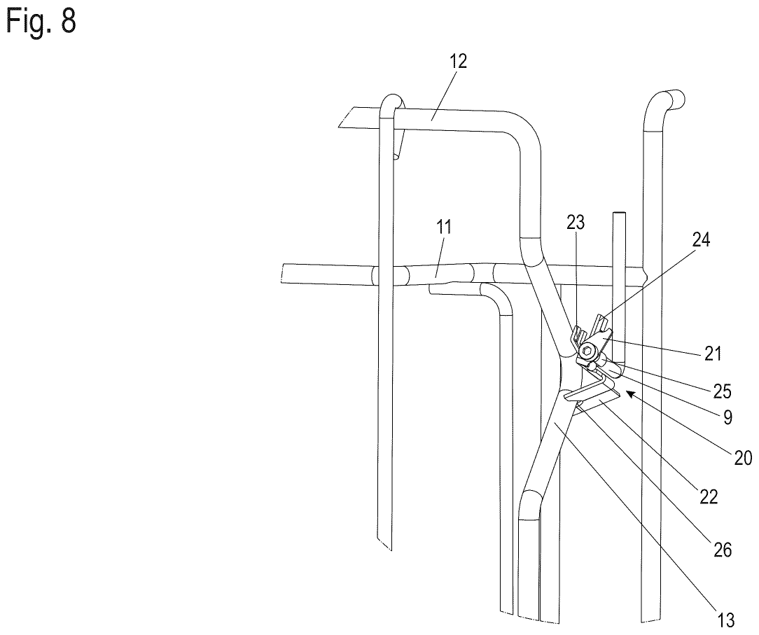

In FIG. 8, the driver 13 has been inserted into the recess 26 on the first actuating section 22. It can be seen that the recess 26 ensures that the driver 13 can be moved further in the extending direction relative to the locking element 20, but in the opposite direction the driver 13 contacts the first actuating section 22 during a retracting movement in order to pivot the locking element 20 counterclockwise. In the locked position, the driver 13 is located between the first actuating section 22 and the second actuating section 23, so that the driver 13 is coupled to the locking element 20 in both directions of movement.

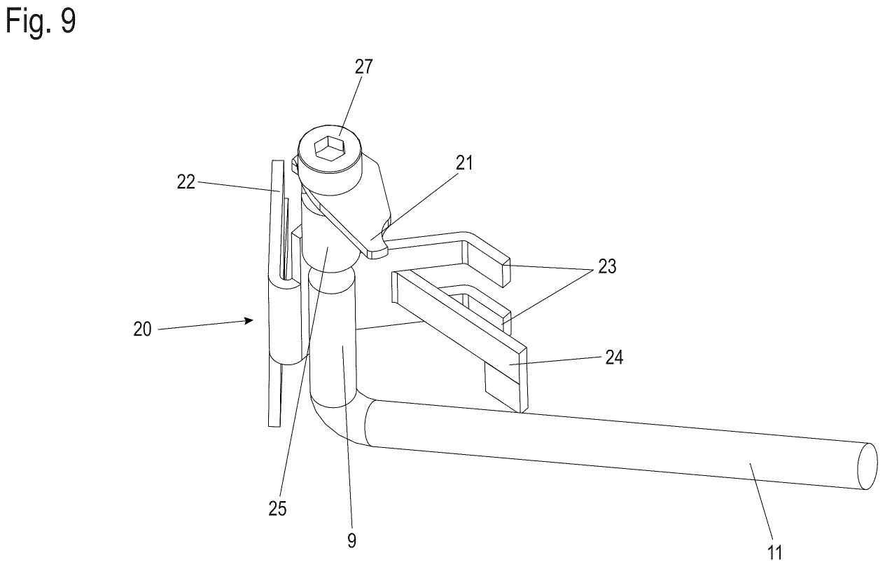

FIG. 9 shows the locking element 20 on the pin 9 of the stationary part 11 in detail. The bearing section 25 surrounds the pin 9 and thus forms an axis of rotation for the locking element 20. The locking element 20 is formed in one piece and comprises the radially protruding locking section 21, the first actuating section 22 and the second actuating section 23, which each protrude in different radial directions. The second actuating section 23 comprises two webs that are angled and form a bevel for the driver 13. Furthermore, the cantilever 24, which limits the rotational movement of the locking element 20 when the driver 13 is moved in the extension direction, is formed integrally with the second actuating section 23. The cantilever 24 can strike against the strut of the stationary part 11. The locking element 20 is secured in the axial direction by a screw 27 or another fastening means.

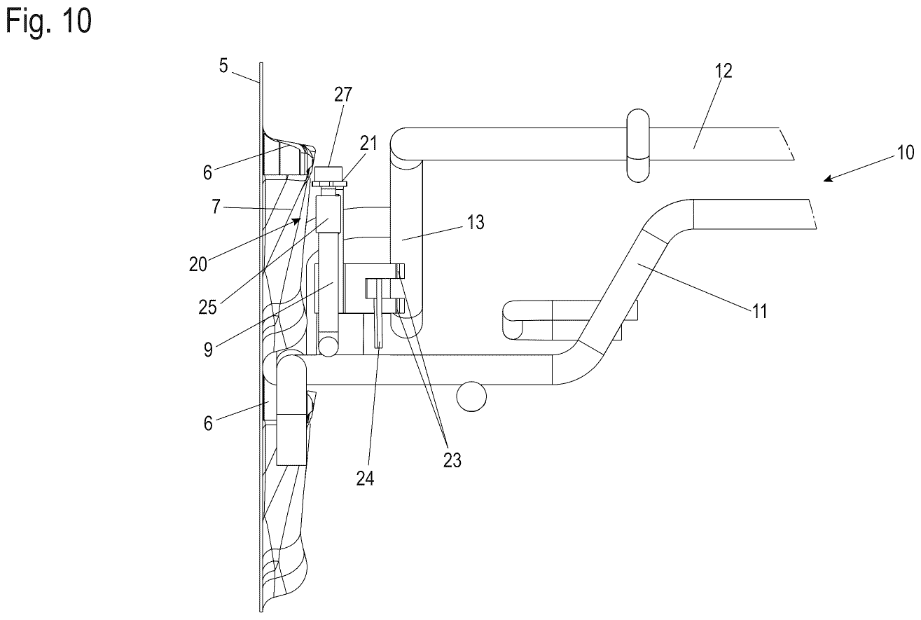

In FIG. 10, the locking mechanism is shown in the installed position in the unlocked position. The second actuating section 23 is in contact with a front side of the driver 13 and, during an extending movement of the movable part 12, the driver 13 rotates the locking element 20 in order to bring it into the locked position.

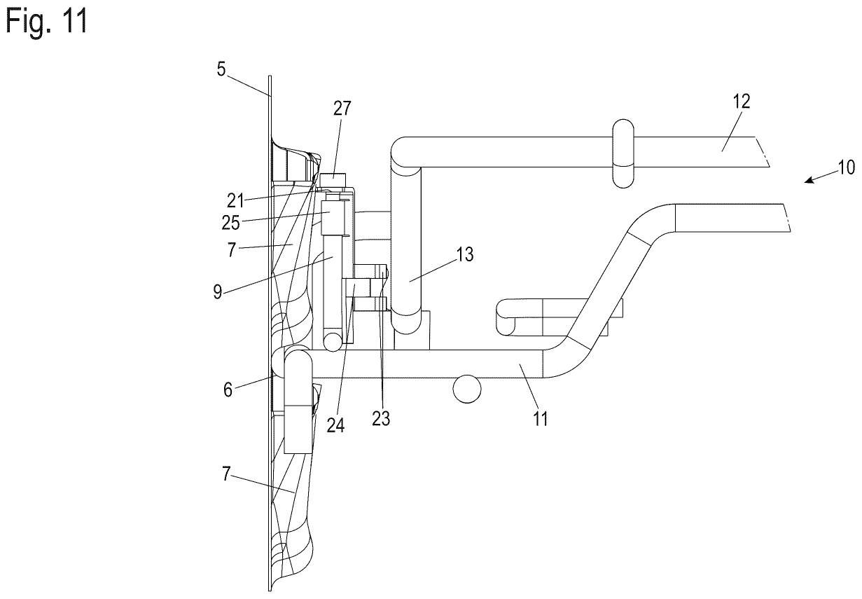

FIG. 11 shows the locked position when the driver 13 on the movable part 12 has been moved in the opening direction. The driver 13 is located below one side of the movable part 12 and has pivoted the second actuating section 23, so that the locking section 21 on the locking element 20 has also been pivoted and is now in engagement with the locking projection 7. Alternatively, the driver 13 can also project obliquely downwards or to the side or be arranged or formed on the second rail 15

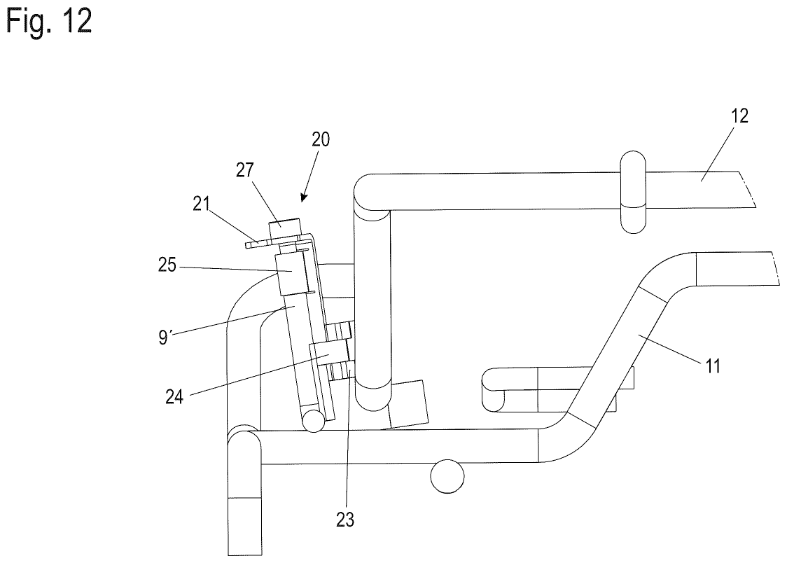

FIG. 12 shows a modified embodiment example of a locking mechanism, in which the locking element 20 is designed as in the previous embodiment example, but is mounted on a pin 9′ of the stationary part 11, which is aligned at an angle to the vertical. The bearing section 25 on the locking element 20 is also inclined about the axis of rotation, but despite the inclination, the locking section 21 can engage with the locking projection 7 during a rotary movement of the locking element 20, as described in the previous embodiment examples. This can enable particularly easy unlocking and, in addition, the locking can be assisted by gravity.

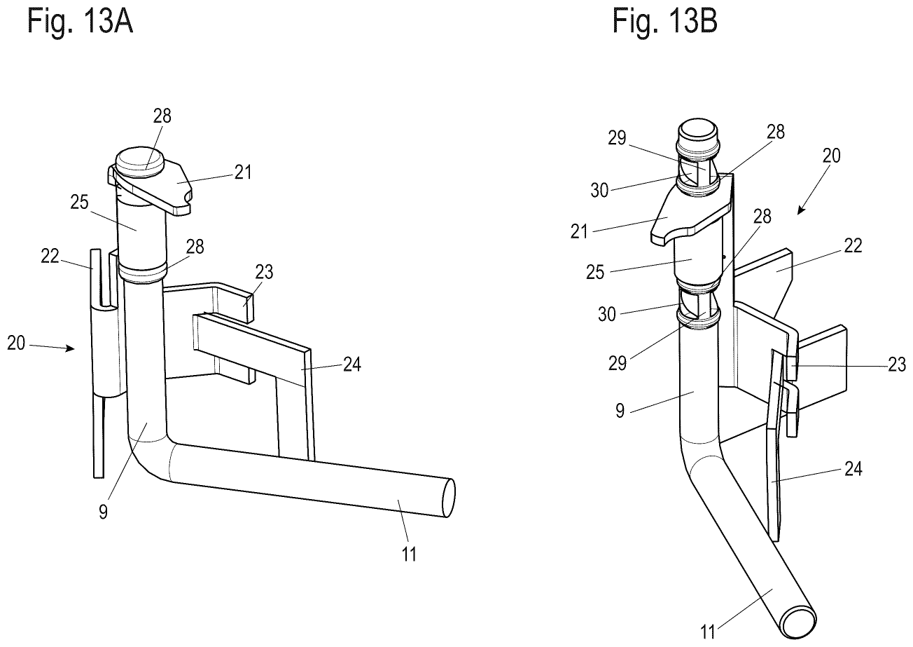

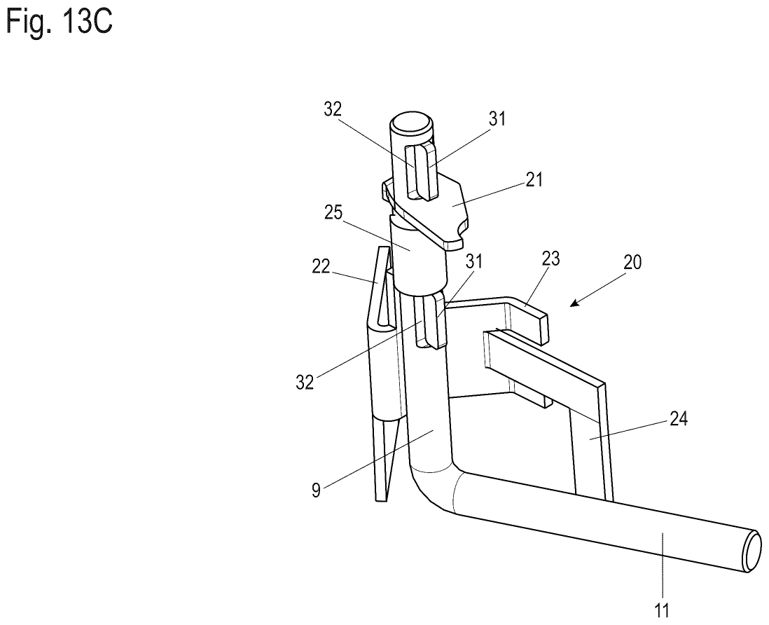

FIGS. 13A to 13C show different variants for fixing the locking element 20 to the pin 9.

In FIG. 13A, two embossed rings 28 are formed on the pin 9, which protrude radially from the pin so that the bearing section 25 is held in the axial direction between the two rings 28. The rings 28 can be produced by upsetting or embossing the pin 9.

In FIG. 13B, an embossing 30 has been made in the pin 9 on both sides of the bearing section 25, so that an axial web 29 and two rings 28 are embossed around the embossing 30. The rings 28 form a stop for the bearing section 25 in the axial direction.

In FIG. 13C, instead of the rings 28, radially protruding webs 31 have been produced next to an indentation 32, which form a stop for limiting the axial movement of the bearing section 25 of the locking element 20.

In the example shown, the wall element 5 is formed by an embossed metal sheet. It is also possible to provide a side grid as a wall element, for example with horizontal struts, to which the rack system 10 can be fixed. In this case, the driver can be arranged or formed on the second rail 15.

Although only a few embodiments of the present invention have been shown and described, it is to be understood that many changes and modifications may be made thereunto without departing from the spirit and scope of the invention.

### LIST OF REFERENCE SYMBOLS

1 Domestic appliance
2 Housing
3 Interior space
4 Door
5 Wall element
6 Support strip
7 Locking projection
8 Receptacle
9, 9′ Pin
10 Rack system
11 Stationary part
12 Movable part
13 Driver
14 Rail
15 Rail
16 Web
20 Locking element
21 Locking section
22 First actuating section
23 Second actuating section
24 Cantilever
25 Bearing section
26 Recess
27 Screw
28 Ring
29 Web
30 Embossing
31 Web
32 Indentation
60 Cantilever
F₁ Tensile force
F₂ Counterforce

What is claimed is:

1. A domestic appliance (1) comprising:
an interior space (3) having opposite sides and being configured for receiving a rack system (10),
a wall element (5) provided on each of the opposite sides of the interior space (3) and
a locking projection (7) arranged on at least one of the wall elements (5),
a stationary part (11) of the rack system arranged in the interior space (3),
a movable part (12) of the rack system, that is movable at least partially in front of the interior space via guides,
a locking element (20) pivotably mounted on the stationary part (11) and being configured for releasable engagement with the locking projection (7), the locking element being configured to be moved into an unlocked position via a driver (13) on the movable part (12), the locking element (20) having a locking section (21) which is configured to be brought into engagement with the locking projection (7) and a first actuating section (22) which is configured to be brought into engagement with the driver (13),
wherein the locking element (20) has a second actuating section (23) which is configured to be brought into engagement with the driver (13), and wherein the driver (13) is held between the first actuating section (22) and the second actuating section (23) in an unlocked position of the locking section (21).

2. The domestic appliance according to claim 1, wherein the locking element (20) is configured to be pivoted relative to the stationary part (11) without support by a spring.

3. The domestic appliance according to claim 1, wherein the locking element (20) is rotatably mounted on the stationary part (11) with a bearing section (25) about a pin (9, 9′) or wire section.

4. The domestic appliance according to claim 1, wherein the first actuating section (22) and the second actuating section (23) project in different radial directions from the locking element (20) with respect to an axis of rotation.

5. The domestic appliance according to claim 1, wherein the locking element (20) is formed in one piece.

6. The domestic appliance according to claim 1, wherein the locking projection (7) is arranged in a region of a front half of the wall element (5) with respect to an extension direction of the movable part (12).

7. The domestic appliance according to claim 1, wherein the locking element (20) is arranged to be self-locking in a locked position and, upon application a tensile force (F₁) on the stationary part (11) in the pull-out direction, a resulting counterforce (F₂) from the locking projection (7) on the locking element (20) pushes the locking element even more strongly into the locked position by the resulting torque.

8. The domestic appliance according to claim 1, wherein the locking section (21) provided on the locking element (20) is subjected to pressure when a tensile force is applied to the stationary part (11) in the pull-out direction.

9. The domestic appliance according to claim 1, wherein a first rail (14) of a pull-out guide is fixed to the stationary part (11) and the movable part is fixed to a second rail (15) of the pull-out guide.

10. The domestic appliance according to claim 1, wherein the driver (13) is designed as a projection which projects downwards and/or laterally from the movable part (12) or from the second rail (15).

11. The domestic appliance according to claim 1, wherein opposite sides of the stationary part (11) are each provided with said locking element (20), each of which is configured to engage with one said locking projection (7) on the respective wall element (5).

12. The domestic appliance according to claim 1, wherein the locking projection (7) is formed on the wall element (5) from an embossed metal sheet or on a side grille.

13. The domestic appliance according to claim 1, wherein the domestic appliance (1) is designed as an oven.
